(19) United States
(12) Patent Application Publication
(10) Pub. No.: US 2011/0121696 A1
(43) Pub. Date: May 26, 2011

(54) BRACKET AND CABINET USING THE SAME

(75) Inventor: Hai-Qing Zhou, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/768,708

(22) Filed: Apr. 27, 2010

(30) Foreign Application Priority Data
Nov. 20, 2009 (CN) 200910310170.9

(51) Int. Cl. F16M 13/00; A47B 81/00

(52) U.S. Cl. 312/223.1; 248/309.2

(57) ABSTRACT

A cabinet includes four pillars, a bracket mounted on the pillars, and an electronic device placed on the wheels. The bracket includes a mounting frame, shafts secured to the mounting frame and wheels on the shafts. When the electronic device is pushed or pulled, the wheels rotate on the shafts, thereby the electronic device easily moves relative to the bracket.

### BACKGROUND

1. Technical Field

The disclosure relates to brackets and, more particularly, to a bracket used in a cabinet for electronic devices.

2. Description of Related Art

Electronic devices, such as servers, are frequently housed in modular form in a standardized enclosure, and are generally rack-mounted in a cabinet. The cabinet includes a plurality of brackets supporting the electronic devices. A typical bracket is a shelf arranged in the cabinet. The electronic devices are directly placed on the shelves, and because of friction, it is often difficult to slide the devices into or out of the cabinet.

What is needed, therefore, is a bracket which overcomes the above-described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of a cabinet in accordance with an embodiment of the disclosure, wherein the cabinet has four pillars, a bracket having four corners mounted on the pillars, and an electronic device disposed on the bracket.

FIG. 2 is an isometric, exploded view of the bracket of the cabinet of FIG. 1.

FIG. 3 shows a wheel disassembled from a shaft of the bracket of the cabinet in FIG. 2.

### DETAILED DESCRIPTION

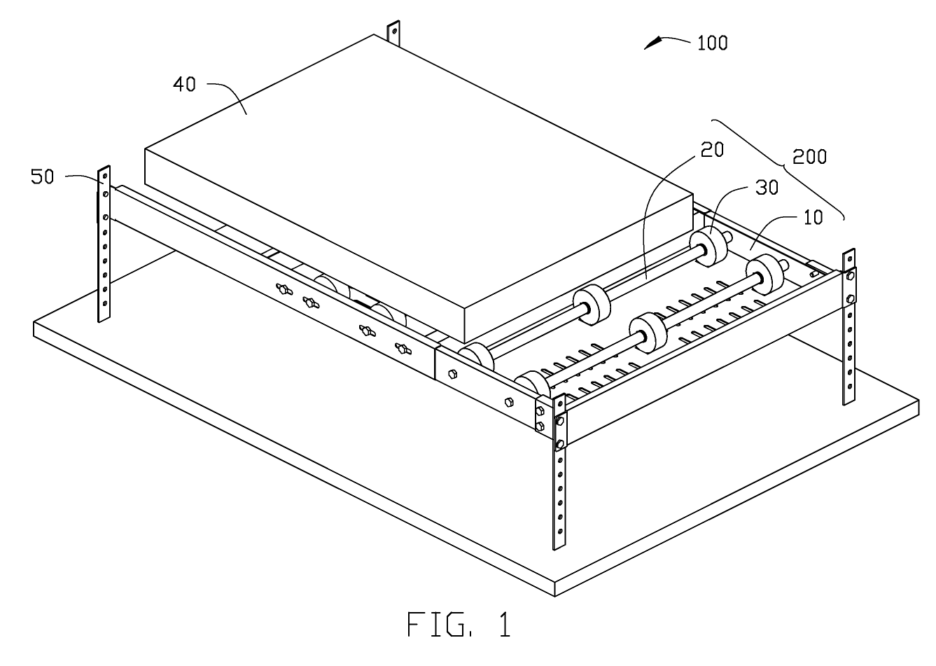

Referring to FIG. 1, a cabinet 100 is illustrated in accordance with an embodiment of the disclosure. The cabinet 100 comprises four pillars 50, a bracket 200 mounted on the pillars 50, and an electronic device 40 placed on the bracket 200. The bracket 200 comprises a mounting frame 10 having four corners thereof mounted on the pillars 50, a plurality of shafts 20 secured to the mounting frame 10, and a plurality of wheels 30 rotatably attached to the shafts 20. The electronic device 40 is placed on the wheels 30. The electronic device 40 may be a server. When pushing or pulling the electronic device 40, the wheels 30 rotate on the shafts 20. The shafts 20 are parallel to each other.

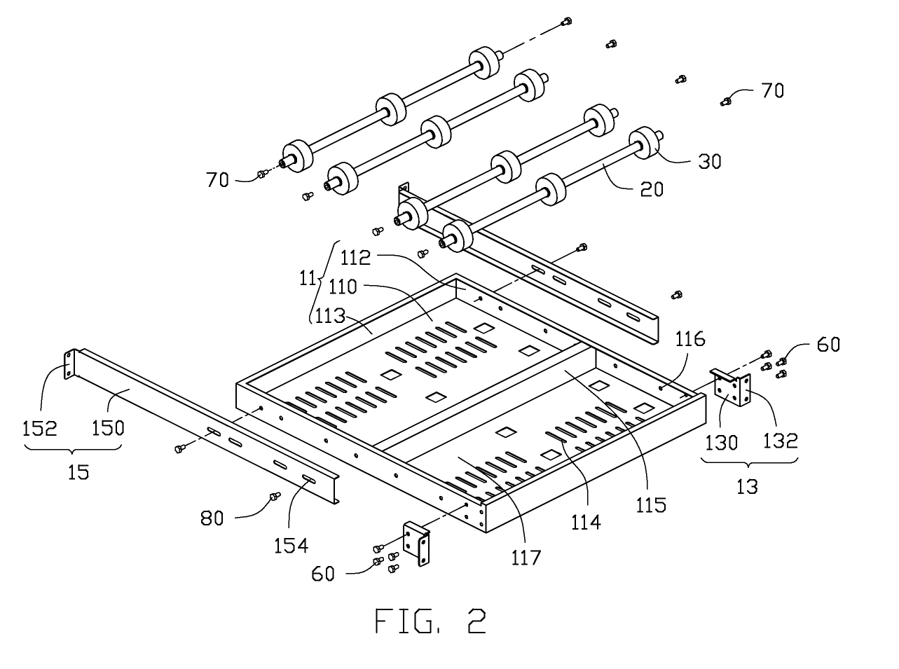

Referring also to FIG. 2, the mounting frame 10 comprises a substantially rectangular tray 11, a pair of first mounting members 13, and a pair of second mounting members 15. The tray 11 comprises a bottom plate 110, two opposite first sidewalls 112, and two opposite second sidewalls 113. The bottom plate 110, and the first and second sidewalls 112, 113 interconnect with each other and cooperatively define a space (not labeled). The first and second sidewalls 112, 113 extend upwardly and perpendicularly from a periphery of the bottom plate 110. The bottom plate 110 defines a plurality of ventilating holes 114 allowing an airflow therethrough. The airflow carries away heat generated by the electronic device 40 so that the electronic device 40 can be cooled down. The first sidewalls 112 are longer than the second sidewalls 113. A plurality of extending holes 116 are defined in the first sidewalls 112.

Each sidewall 112 has one each of the first and second mounting members 13, 15 respectively mounted on opposite ends thereof. Each of the first mounting members 13 comprises a securing sheet 130 mounted to a side of the first sidewall 112 via fasteners 60, and a mounting sheet 132 extending outwardly and perpendicularly from an end of the securing sheet 130. Each of the second mounting members 15 comprises a securing plate 150 mounted to the side of the first sidewall 112, and a mounting plate 152 extending outwards and perpendicularly from an end of the securing plate 150. The securing plate 150 has a U-shaped cross section, and encircles three sides of the first sidewalls 112. The securing plate 150 defines a plurality of slots 154 therein. The mounting sheets 132 and the mounting plates 152 are secured to four pillars 50, respectively. To enhance an intensity of the tray 11, a rib 115 extends upwardly from the bottom plate 110, and divides the space of the tray 11 into two receiving spaces 117. The rib 115 extends to the first sidewalls 112 and connects with the first sidewalls 112.

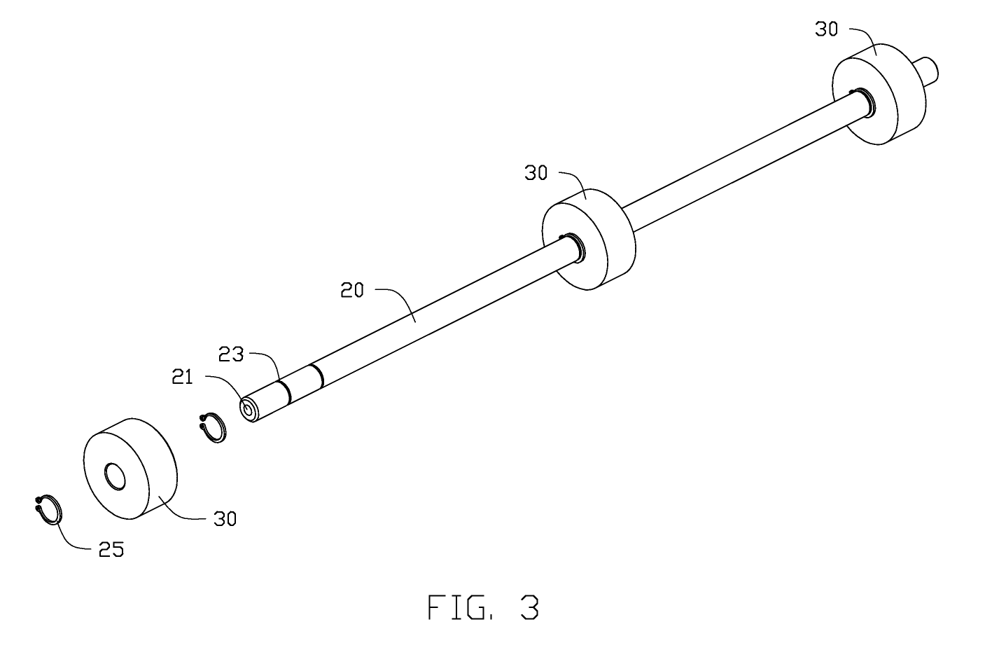

Also referring to FIG. 3, each of the shafts 20 defines a blind hole 21 in each of two opposite ends thereof along an axis of the shaft 20. Each of the shafts 20 defines three pairs of annular grooves 23 corresponding to the wheels 30. The pairs of grooves 23 are spaced from each other. Each of the wheels 30 is located between a corresponding pair of grooves 23. Three pairs of retaining members 25 are engaged in the pairs of grooves 23 to prevent the wheels 30 from sliding along the shaft 20. In this embodiment, three wheels 30 are used. In other embodiments, the number of the wheels 30 can be changed according to actual needs.

In assembly of the bracket, the fasteners 60 are extended through the securing sheets 130 and securely engaged in the first sidewall 112. Four fasteners 80 are extended through the slots 154 and engaged in the extending holes 116, thereby securing the second mounting members 15 to the first sidewalls 112. Four of the fasteners 70 are respectively extended through the slots 154 and corresponding extending holes 116 to engage in the blind holes 21 of two of the shafts 20, thereby mounting the two shafts 20 in the tray 11. The two shafts 20 are received in one of the receiving spaces 117. The other four of the fasteners 70 are extended through the extending holes 116 and engaged in the blind holes 21 of the other two shafts 20, thereby mounting the other two shafts 20 onto the tray 11. The other two shafts 20 are received in the other one of the receiving spaces 117. A length of the bracket 200 can be adjusted by changing locations of the fasteners 80 and the four of fasteners 70 relative to corresponding slots 154 to be fit for different electronic device 40 having different lengths.

The wheels allow the electronic device 40 to be easily pushed into or pulled from the cabinet 100 by riding on the wheels. Alternatively, the mounting frame 10 may be two beams (not labeled) mounted in parallel on the pillars 50. The fasteners 70 are extended through the beams and engaged in the blind holes 21 of the shafts 20 so that the shafts 20 are mounted on the mounting frame 10.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A bracket for supporting an electronic device, comprising:
a mounting frame;
a plurality of shafts secured to the mounting frame; and
at least two wheels rotatably attached to each of the shafts.

2. The bracket of claim 1, wherein each of the shafts defines at least two pairs of grooves, each of the wheels being located between a corresponding pair of grooves.

3. The bracket of claim 2, wherein two retaining members are engaged in each pair of the grooves to prevent the wheel between the pair of the grooves from sliding along the shaft.

4. The bracket of claim 1, wherein each of the shafts defines two blind holes in two opposite ends thereof along an axis of the shaft for securing the shaft to the mounting frame.

5. The bracket of claim 1, wherein the mounting frame comprises a tray, two first mounting members and two second mounting members; the tray comprises a bottom plate, two opposite first sidewalls, and two opposite second sidewalls; one of the first mounting members and one of the second mounting members are mounted on two opposite ends of a corresponding one of the first sidewalls, the first and second sidewalls extending upwardly from a periphery of the bottom plate.

6. The bracket of claim 5, wherein each of the first mounting members comprises a securing sheet mounted to a side of the corresponding one of the first sidewalls and a mounting sheet extending outwardly and perpendicularly from an end of the securing sheet, and each of the second mounting members comprises a securing plate mounted to the side of the corresponding one of the first sidewalls and a mounting plate extending outwards and perpendicularly from an end of the securing plate.

7. The bracket of claim 5, wherein each of the shafts has two opposite ends thereof secured to the first sidewalls, respectively.

8. The bracket of claim 5, further comprising a rib extending upwards from the bottom plate of the mounting frame to enhance an intensity of the tray, wherein the rib extends to the first sidewalls and connects with the first sidewalls.

9. A cabinet comprising:
four pillars;
a bracket mounted on the pillars, the bracket comprising a mounting frame, a plurality of shafts secured to the mounting frame and at least two wheels rotatably attached to each of the shafts; and
an electronic device placed on the wheels;
wherein when the electronic device is pushed or pulled on the wheels, the wheels rotate relative to corresponding shafts, thereby the electronic device moves relative to the bracket.

10. The cabinet of claim 9, wherein each of the shafts defines at least two pairs of grooves, each of the wheels being located between a corresponding pair of grooves.

11. The cabinet of claim 10, further comprising two retaining members engaged in each pair of the grooves to prevent the wheel between the pair of the grooves from sliding along the shaft.

12. The cabinet of claim 9, wherein each of the shafts defines two blind holes in two opposite ends thereof along an axis of the shaft for securing the shaft to the mounting frame.

13. The cabinet of claim 9, wherein the mounting frame comprises a tray, two first mounting members and two second mounting members, the tray comprising a bottom plate, two opposite first sidewalls, and two opposite second sidewalls, one of the first mounting members and one of the second mounting members being mounted on two opposite ends of a corresponding first sidewalls, the first and second sidewalls extending upwardly from a periphery of the bottom plate.

14. The cabinet of claim 13, wherein each of the first mounting members comprises a securing sheet mounted to a side of the corresponding one of the first sidewalls and a mounting sheet extending outwardly and perpendicularly from an end of the securing sheet, and each of the second mounting members comprises a securing plate mounted to the side of the corresponding one of the first sidewalls and a mounting plate extending outwards and perpendicularly from an end of the securing plate.

15. The cabinet of claim 14, wherein each of the shafts has two opposite ends thereof secured to the first sidewalls, respectively.

16. The cabinet of claim 14, wherein the mounting sheets of the first mounting members and the mounting plates of the second mounting members are secured to four pillars, whereby the bracket is kept in a horizontal state.

17. The cabinet of claim 13, further comprising a rib extending upwards from the bottom plate of the mounting frame to enhance an intensity of the tray, wherein the rib extends to the first sidewalls and connects with the first sidewalls.
